(19) United States
(12) Patent Application Publication
(10) Pub. No.: US 2008/0182703 A1
(43) Pub. Date: Jul. 31, 2008

(54) SPUR WHEEL DIFFERENTIAL WITH A PLANETARY GEAR

(75) Inventor: Thorsten Biermann, Muhlhausen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/972,119

(22) Filed: Jan. 10, 2008

(30) Foreign Application Priority Data
Jan. 25, 2007 (DE) 102007003675.4

(51) Int. Cl. F16H 48/06

(52) U.S. Cl. 475/253

(57) ABSTRACT

A spur wheel differential with improved operating properties are achieved while maintaining the compact construction. The spur wheel differential 1, particularly for a motor vehicle, includes a planetary gear with a planet carrier 3 constructed as a sum shaft, with two differential shafts, which are arranged coaxial to the sum shaft and which form the driven part for the spur wheel differential 1, and with roller bearing devices 4 for two-sided support of the planet carrier, wherein at least one part of the roller bodies 5 of the roller bearing devices 4 has a curved or domed stop face in the axial direction A of the spur wheel differential 1.

### CROSS-REFERENCE TO RELATED APPLICATIONS

This application claims the benefit of DE 10 2007 003 675.4, filed Jan. 25, 2007, which is incorporated herein by reference as if fully set forth.

### BACKGROUND

The invention relates to a spur wheel differential with a planetary gear.

A differential is a gear, which is used in drive trains of motor vehicles and is connected, e.g., between the driving wheels of an axle, in order to allow the wheels connected via the differential to compensate for different traversed paths. This is necessary, e.g., when driving around a curve, in which the outer wheel of an axle covers a greater path than the inner wheel of the same axle, wherein without a differential the path difference would be compensated, e.g., through the wheels grinding or skidding on the roadbed.

The differential, or also called differential gear, has, in general, a sum shaft, by means of which the differential is driven and is often constructed as a differential gear case with planet wheels arranged in this gear case so that they can rotate on pins. These planet wheels mesh with driven gears, which distribute the drive power to the wheels by the differential shafts. When the motor vehicle is driven along a straight path, the differential rotates as a block, wherein in the interior of the differential, the gears, that is, the planet wheels and the driven gears are fixed relative to each other. Only when a differential rotational speed appears on the driven wheels do the gears roll in the interior of the differential on each other.

In EP 0918177 A1, a spur wheel differential is disclosed, which no doubt forms the closest state of the art. The spur wheel differential has a differential gear case, which can be driven by a driving element and which has several planet wheels that have external teeth and that are engaged with each other and that interact with geared driven wheels. Therefore, because the driven wheels with annular or pot-shaped sections mesh with the planet wheels via internal teeth, it is possible that the spur wheel differential has a very compact and simultaneously robust construction. The bearing of the differential gear case is provided as biased conical roller bearings arranged on both sides coaxial to the driven gears.

### SUMMARY

The invention is based on the objective of refining a spur wheel differential according to the class, so that improved operating properties are achieved.

This objective is met with a spur wheel differential with a planetary gear according to the invention. Preferred or advantageous embodiments are provided below in the following description, claims and also the enclosed figures.

According to the invention, a spur wheel differential with a planetary gear designed, in particular, for a motor vehicle, is provided. The spur wheel differential is constructed, in particular, to drive two wheels of a common axle, in order to distribute the output of a motor between two axles.

The spur wheel differential has a planet carrier constructed as a sum shaft, wherein the sum shaft forms the drive for the spur wheel differential. The sum shaft or the planet carrier has radial, peripheral spur gearing or a radial, peripheral ring gear. The spur gearing selectively has a straight, that is, axis-parallel, inclined, or curved gear construction.

The planet carrier supports a plurality of planet wheels, which are arranged so that the torque introduced into the planet carrier is forwarded or distributed via the planet wheels to two differential shafts arranged coaxial to the sum shaft. In particular, according to the understanding of someone skilled in the art the sum shaft is the shaft of a planetary gear that carries the greatest torque or the greatest torques, wherein this incoming or drive torque is distributed in the spur wheel differential to the two difference shafts of the planetary gear.

The differential shafts form the driven part for the spur wheel differential and forward the distributed torques, for example, to drive wheels of the vehicle.

For supporting the planet carrier and/or the sum shaft, there are roller bearing devices, which support the planet carrier and/or the sum shaft on both sides in the axial extent of the spur wheel differential. According to the invention it is provided that at least one part of the roller bodies of the roller bearing devices has a curved or domed stop face and/or contour in the axial direction of the spur wheel differential.

Thus, in contrast to the supporting of the spur wheel differential by conical roller bearings known from the state of the art, roller bearing devices, which have a rollable contour in the axial direction, are used.

Here, the invention starts from the consideration that for the known support using conical roller bearings due to the linear roller contact and especially the friction of the conical rollers on the rim of the bearing ring, relatively high coefficients of friction are produced in the support of the sum shaft. According to the invention, therefore, it is proposed to replace the conical roller bearing of the known spur wheel differential by a bearing, in which a curved and/or domed stop face is provided at least for a part of the roller body in the axial direction of the spur wheel differential, in order to realize the rolling of the roller body in the peripheral direction with less friction, so that the advantage of the proposed bearing lies in significantly smaller coefficients of friction. In addition, biasing losses, such as those that occur, for example, in conical roller bearings in biased systems, are reduced. In principle, ball bearings, especially single-row or multiple-row angular ball bearings or four-point bearings, which are installed in a tandem, X, or O arrangement, are suitable.

In a preferred embodiment, the roller bodies are arranged and/or constructed with the curved and/or domed stop face, so that the roller body can rotate about a rotational axis, which is arranged perpendicular and/or essentially perpendicular to the axial direction of the spur wheel differential. With this arrangement, the roller bodies are in the position to roll in the peripheral direction on a running surface, which is aligned at least partially perpendicular or perpendicular to the axial direction of the spur wheel differential.

In a preferred construction, the roller bearing devices are each constructed as an angular ball-bearing device and/or as a tandem bearing on both sides. This embodiment is preferably used in a biased system, wherein both identical and also different roller bearing devices can be arranged on the two sides. In particular, in this construction, the angular ball bearing devices are each constructed in a single row and positioned relative to each other in an X arrangement, especially so that the tips of the cones formed by the ball thrust lines point radially inward. In one possible alternative, the roller bearing device is constructed as a tandem bearing on at least one side of the spur wheel differential, in particular, as a multiple-row ball bearing, in which the pressure angles of the individual ball rows each have the same sign. For the use of a tandem bearing, an X arrangement of the roller bearing devices arranged on both sides is also preferred.

In an advantageous construction, the roller bearing devices are arranged and/or constructed as fixed-movable bearings. For this construction, a roller device on one side of the spur wheel differential takes over the task as a fixed bearing and in this way receives both axial and also radial forces. The other roller bearing device on the other side is realized as a movable bearing, which receives exclusively radial forces.

In one construction of the fixed-movable bearing, the movable bearing is constructed as a needle bearing and the fixed bearing is constructed as two angular ball bearings in an O arrangement or as a two-row ball bearing in an X or O arrangement or as a grooved ball bearing or as a four-point bearing. In the four-point bearing, special advantages are to be seen in that this requires significantly less installation space than a comparable two-row angular ball bearing and has a higher load rating than a grooved ball bearing of comparable installation space due to the track geometry.

In a preferred improvement, on at least one side of the spur wheel differential, the roller body device is constructed as a combination radial-axial bearing. In this way, the roller body device has a radial bearing and an axial bearing section, so that both radial and also axial forces are received.

In a preferred embodiment, the combination radial-axial bearing is constructed as a combination of a radial needle collar and an axial needle bearing. Alternatively, the combination radial-axial bearing can also be formed as a combination of a ball bearing and a needle bearing.

In a preferred embodiment, the spur wheel differential is constructed as a lightweight differential, wherein the differential shafts have pot-shaped driven wheels, which engage around the planet wheels of the planetary gear. In particular, the spur wheel differential is constructed with the features according to the spur wheel differential of publication EP 0918177A1, whose disclosure is incorporated here by reference as if fully set forth.

The spur wheel differential according to the invention provides a differential gear case, in which the planet wheels are arranged. The differential gear case is preferably realized as a sheet-metal construction and has housing shells on both sides, which form the lateral covers of the differential gear case and which are connected directly to a spur wheel or a ring gear. At least one of the housing shells has running surfaces formed in one piece and/or arranged for the rolling body and/or a part of the rolling body, wherein the running surfaces are preferably arranged in one piece on collars, which are formed on the housing shells and which are designed selectively as internal or external rings of the roller bearing device. The production of the housing shells can be realized optionally in a metal-cutting way. Alternatively the housing shells are produced without cutting, especially with a metal-shaping process. Additionally, through metal-removing processes, for example, grinding, the collars and/or the housing shells can be provided with one or more tracks, in particular, ball tracks.

Thus, the subject matter of the invention is also to provide a spur wheel differential, which has a housing shell that is used simultaneously as a bearing ring. Such a housing shell can be used both on one side and also on both sides of the spur wheel differential.

### BRIEF DESCRIPTION OF THE DRAWINGS

Additional features, advantages, and effects of the invention emerge from the following description of preferred embodiments of the invention. Shown are:

FIG. 1 a schematic, three-dimensional view of spur wheel differential with a first bearing alternative as a first embodiment of the invention;

FIG. 2 a view similar to the spur wheel differential shown in FIG. 1 with a second bearing alternative as a second embodiment of the invention;

FIG. 3 a view similar to the spur wheel differential in FIG. 1 with a third bearing alternative as a third embodiment of the invention;

FIG. 4 a view similar to the spur wheel differential in FIG. 1 with a fourth bearing alternative as a fourth embodiment of the invention;

FIG. 5 a view similar to the spur wheel differential in FIG. 1 with bearing rings formed in one piece on the housing shell as a fifth embodiment of the invention;

FIG. 6 a view similar to the spur wheel differential in FIG. 1 with bearing rings formed in one piece on the housing shell as a sixth embodiment of the invention.

### DETAILED DESCRIPTION OF THE PREFERRED EMBODIMENTS

Identical or corresponding reference symbols in the figures relate to identical or corresponding parts.

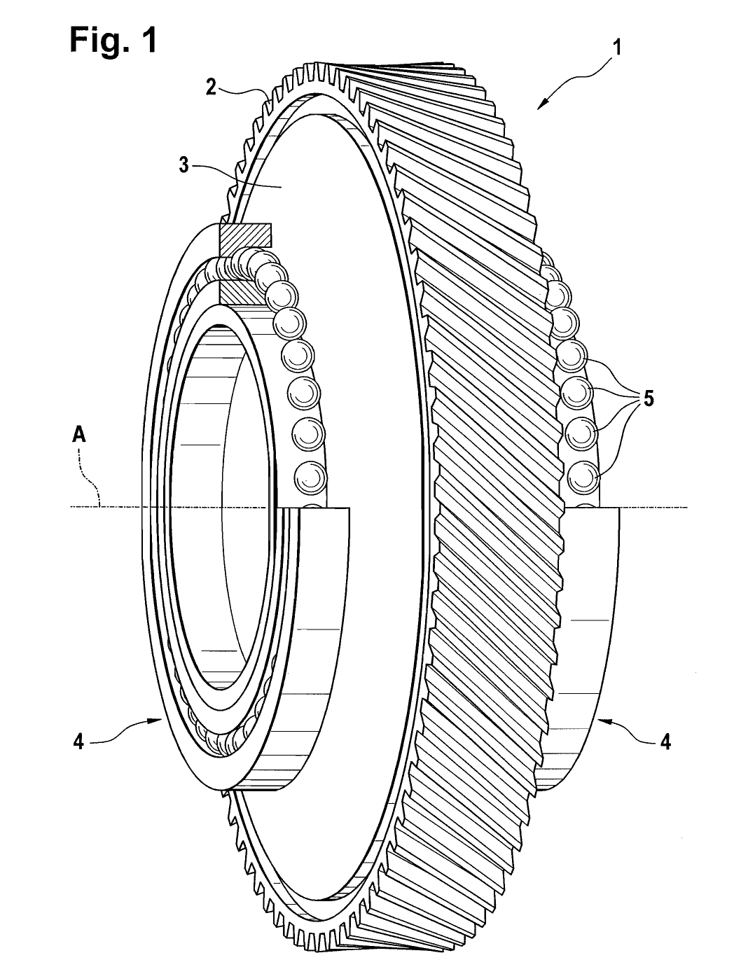

In a schematic three-dimensional representation, FIG. 1 shows the housing of a spur wheel differential 1, which is used, for example, in vehicles for balancing the torque of the wheels of a common axle or for distributing the torque between two axles. The spur wheel differential 1 has a radial, helical geared spur wheel 2, by which the spur wheel differential 1 is driven, so that it is set in rotation about an axis of rotation A. The spur gear 2 is connected rigidly to two housing shells 3 and forms, together with this, a differential gear case, in which a planetary gear is arranged, wherein the differential gear case forms the planet carrier. In terms of function, the differential gear case acts as a sum shaft of the planetary gear.

Arranged in the interior of the spur wheel differential 1 and therefore covered in FIG. 1, there are planet wheels, which transmit the torque introduced via the sum shaft as a drive to the (also not shown) differential shafts, which project on both sides from the spur wheel differential 1 coaxial to the rotational axis A. For a uniform torque distribution, like, for example, when a vehicle is being driven along a straight path, the spur wheel differential 1 is driven via the spur gearing 2 nearly as a rigid block, wherein the differential shafts rotate with the same rotational speed as the entire spur wheel differential 1. As soon as the torque output with respect to the two differential shafts becomes non-uniform, the planetary gear exerts a balancing effect, so that the sum shaft and differential shafts have different rotational speeds.

In order to support the spur wheel differential 1 relative to a vehicle-fixed or stationary holder, the spur wheel differential 1 has a roller bearing device 4 on both sides, which are formed in FIG. 1 as a one-row angular ball bearing, which are used relative to each other in an X arrangement. The roller bodies 5 of the roller body devices 4 are constructed as balls and therefore feature, in the axial direction A of the spur wheel differential 1, a curved or domed, here a circular stop face. This construction permits friction losses, which appear due to biasing of the roller bearing device and also due to the rotation of the spur wheel differential 1, to be minimized.

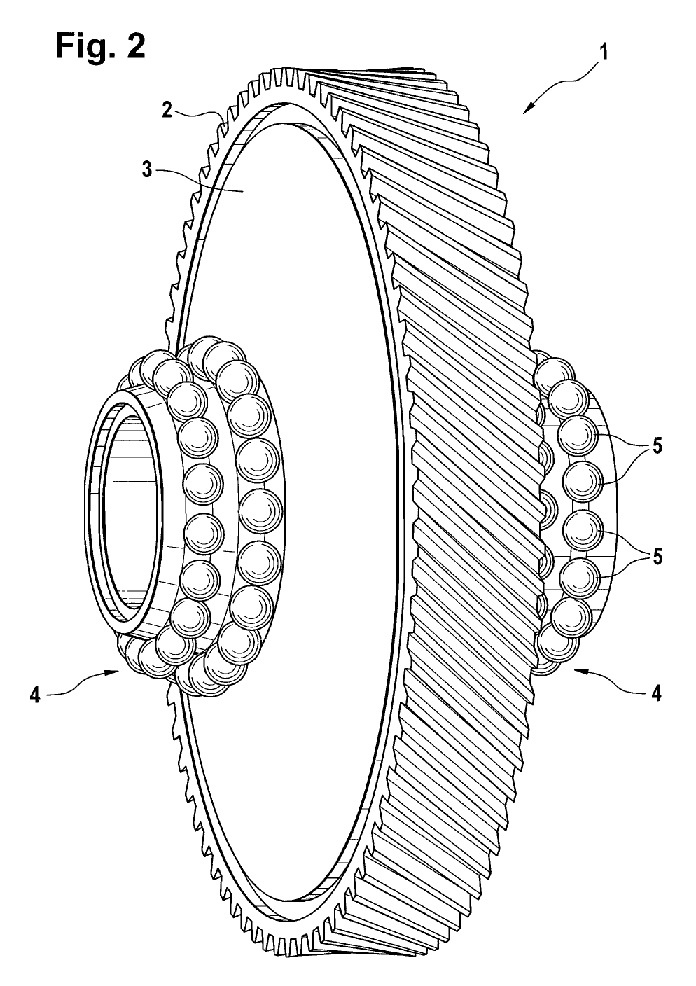

FIG. 2 shows a modified embodiment of the spur wheel differential 1 of FIG. 1 in the same orientation, which differs essentially by the construction of the roller bearing devices 4. For the embodiment in FIG. 2, the roller bearing devices 4 are each formed in a tandem arrangement or as a tandem bearing, which are arranged in an X arrangement relative to each other, so that the spur wheel differential 1 is biased. Tandem bearings are multiple-row ball bearings, in which the pressure angle of the individual ball rows have the same sign and correspond in terms of stiffness and carrying capacity approximately to conical roller bearings of similar installation space.

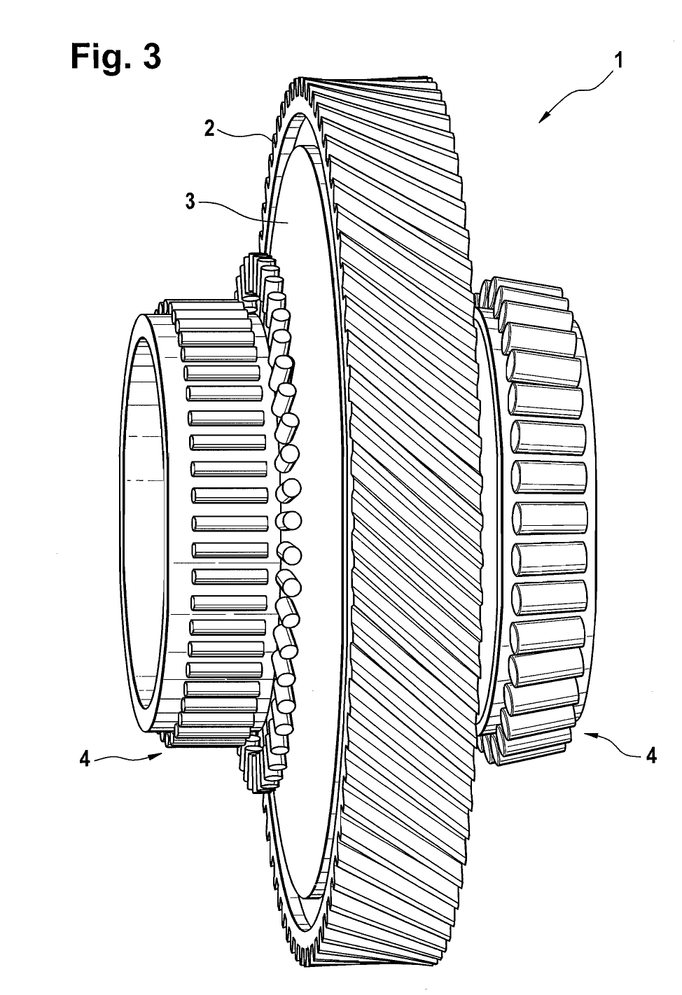

FIG. 3 shows another embodiment of the spur wheel differential 1 with another bearing alternative, wherein on one side the roller bearing device 4 is constructed as a conical roller bearing and on the other side as a combination radial-axial roller bearing. The combination radial-axial roller bearing has a radial needle collar and an axial needle bearing, so that the spur wheel differential on this side is supported both in the axial and also radial directions and, in particular, a counter tension to the conical roller bearing is formed on the opposite side. The roller bodies of the axial needle bearing have in the axial direction A of the spur wheel differential 1 a curved and/or domed stop face, here shaped in section as a needle or semi-circle.

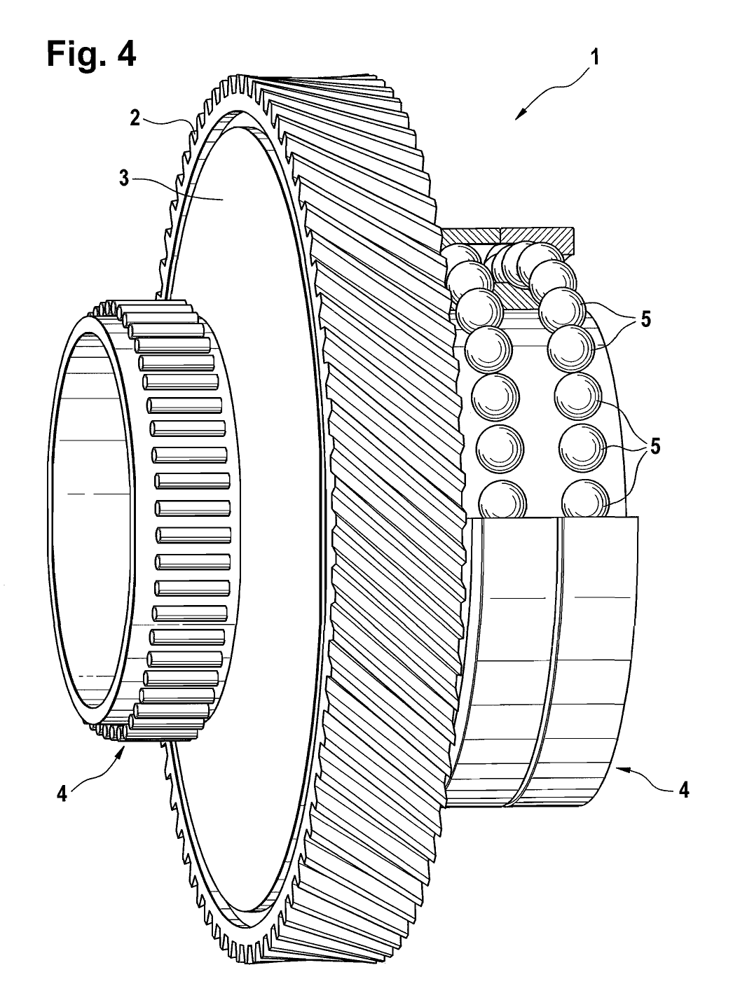

FIG. 4 shows another embodiment of a spur wheel differential 1, wherein a fixed-movable bearing is realized as another bearing alternative. On one side, the spur wheel differential 1 is supported by a roller body device 4, which is formed as two angular ball bearings in an O arrangement. In the O arrangement, the tips of the cone formed by the ball thrust lines point radially outward. On the opposite side, the spur wheel differential 1 is supported, in contrast, with a roller body device 4 in the form of a needle collar. For this bearing, the axial forces are received by the angular ball bearings. As an alternative to the two angular ball bearings, in additional embodiments, a two-row bearing in X or O arrangement, a grooved ball bearing, or a four-point bearing is also possible.

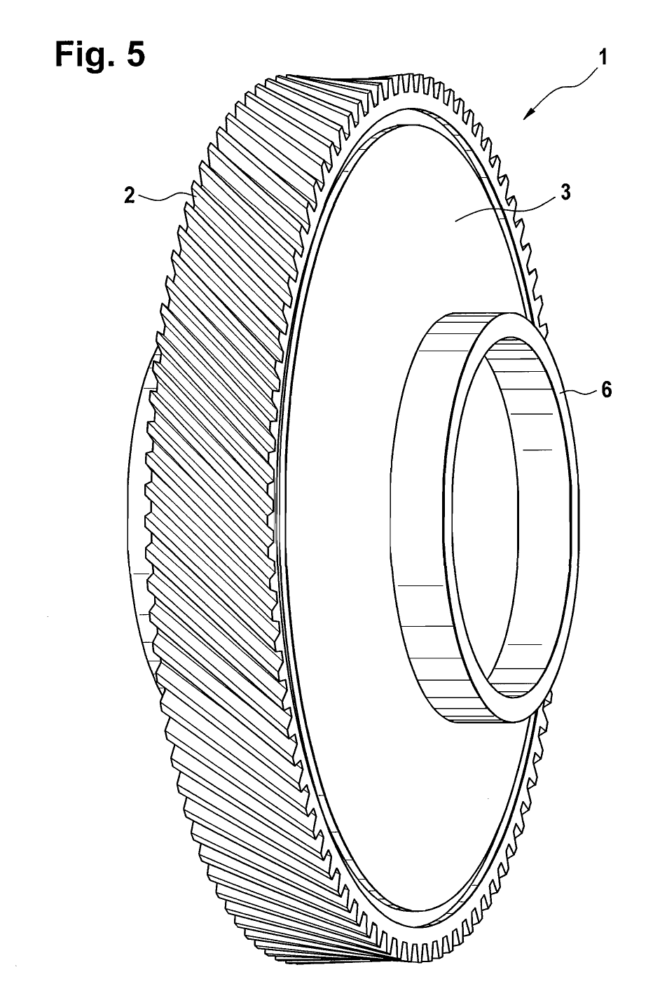

FIG. 5 shows an especially advantageous embodiment of the spur wheel differential 1 in terms of production, wherein the housing shell 3 and a bearing ring 6, which has a track for the roller bodies 5, are formed in one piece. Such a housing shell 3 can be produced, for example, through metal cutting or economically through metal-shaping methods. The bearing ring 6 formed as a collar can be realized as an inner or outer ring of the roller bearing device 4.

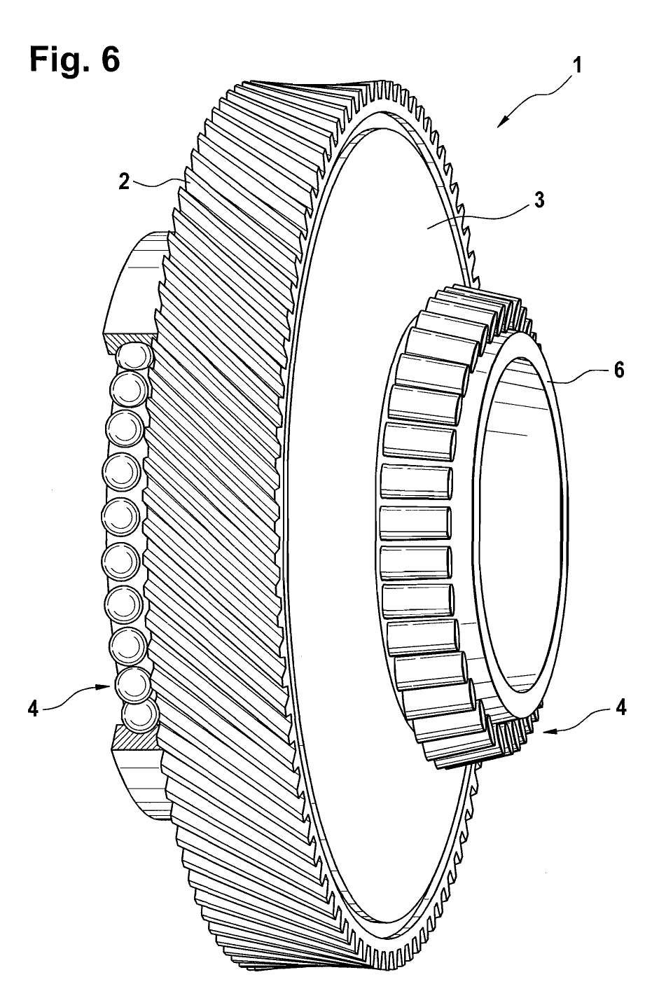

FIG. 6 finally shows a spur wheel differential 1, which has, on one side, a conical roller bearing as a roller bearing 4 and, on the other side, a two-row ball bearing in an O arrangement, wherein the running surfaces for the conical the conical roller bearing and/or for the balls of the ball bearing is or are on bearing rings 6 formed in one piece on the housing shell 3.

### LIST OF REFERENCE SYMBOLS

1 Spur wheel differential
2 Spur gearing
3 Housing shell
4 Roller bearing device
5 Roller body
6 Bearing ring

1. Spur wheel differential with a planetary gear for a motor vehicle, comprising a planet carrier constructed as a sum shaft, with two differential shafts, which are arranged coaxial to the sum shaft and which form a drive for the spur wheel differential, roller bearing devices for two-sided support of the planet carrier, at least one part of the roller bodies of the roller bearing devices has a curved and/or domed stop face in an axial direction of the spur wheel differential.

2. Spur wheel differential according to claim 1, wherein the roller bodies are arranged and/or constructed with the curved and/or domed stop face, in order to allow a rotation of the roller body about a rotational axis, which is arranged generally perpendicular to the axial direction of the spur wheel differential.

3. Spur wheel differential according to claim 1, wherein the roller bearing device is constructed as an angular ball bearing device and/or tandem bearing.

4. Spur wheel differential according to claim 1, wherein the roller bearing devices are arranged and/or constructed as fixed-movable bearings.

5. Spur wheel differential according to claim 4, wherein on one side of the spur wheel differential, the roller body device comprises a needle bearing and on the other side, the roller body bearing device comprises two angular ball bearings in an O arrangement or a two-row ball bearing in an X or O arrangement or a grooved ball bearing or a four-point bearing.

6. Spur wheel differential according to claim 1, wherein the roller body device comprises a combination radial-axial bearing at least on one side of the spur wheel differential.

7. Spur wheel differential according to claim 6, wherein at least on the one side the roller body device is formed as a combination of a radial needle collar and an axial needle bearing.

8. Spur wheel differential according to claim 6, wherein at least on one side the roller body device comprises a combination of a ball bearing and a needle bearing.

9. Spur wheel differential according to claim 1, wherein the spur wheel differential comprises a lightweight differential, wherein the differential shafts have pot-shaped driven wheels, which encompass the planet wheels of the planetary drive.

10. Spur wheel differential according to claim 1, wherein the spur wheel differential comprises a differential gear case, which has peripheral spur gearing and is enclosed on both sides by housing shells, and the housing shells have running surfaces formed in one piece and/or arranged thereon for the roller bodies and/or a part of the roller bodies.
